(19) United States
(12) Patent Application Publication
(10) Pub. No.: US 2009/0160076 A1
(43) Pub. Date: Jun. 25, 2009

(54) Arrangement for Guiding a Mold Set Relative to a Hot Runner in a Molding System and a Method Thereof

(75) Inventors: Adrian Peter Looije, Aurora (CA); James Rodrigues, Caledon (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/960,860

(22) Filed: Dec. 20, 2007

(51) Int. Cl. B29C 45/17

(52) U.S. Cl. 264/40.5; 425/567

(57) ABSTRACT

Provided are an arrangement for guiding a mold set relative to a hot runner in the molding system and a method thereof. For example, an arrangement for guiding a mold set relative to a hot runner, the mold set including a cavity half and a core half, the mold set and the hot runner for use in a molding machine, is provided. The arrangement comprises a guiding member disposed on the hot runner; a guided member disposed on the cavity half; the guiding member and the guided member configured to cooperate to guide the mold set relative to the hot runner in a first direction and, sequentially, in a second direction, the second direction traversing the first direction.

### FIELD OF THE INVENTION

The present invention generally relates to, but is not limited to, a molding system, and more specifically the present invention relates to, but is not limited to, an arrangement for guiding a mold set relative to a hot runner in the molding system and a method thereof.

### BACKGROUND OF THE INVENTION

Molding is a process by virtue of which a molded article can be formed from molding material by using a molding system. Various molded articles can be formed by using the molding process, such as an injection molding process. One example of the molded article that can be formed, for example, from polyethylene terephthalate (PET) material is a preform that is capable of being subsequently blow-molded into a beverage container, such as, a bottle and the like.

In an ongoing quest to improve productivity of molding systems with an outlook to improve output per capita ratio, several productivity-enhancement initiatives have been pursued in the industry. One such initiative is to increase cavitation of a given mold installed in a given molding system. Another such initiative is to increase the number of molds installed within the given molding system—a system that is commonly known in the art as a multi-level stack mold. Within such an arrangement two or more molds, arranged in series, are actuated by a single clamp mechanism through a series of linkages.

With further market pressures on converters (i.e. entities who use molding systems to convert plastic materials into molded articles) to improve cost structures to enable them to offer competitively priced molded articles and, especially, where the molding system is required to be capable of making a number of different parts, emphasis has been placed on delivering a molding system that provides for quick and inexpensive mold change.

As an example of such system, co-owned US patent application 2006/0083803 to DiSimone published on Apr. 20, 2006 discloses a guiding system for guiding a moldset onto a molding machine. The guiding system includes guide grooves on each side of a core plate of the moldset and guide slots on a face of the machine. A slightly raised surface is provided in a top portion of the guide slots and a wedge shaped portion is provided at a base of the guide slots. The moldset is inserted into the machine by guiding the grooves into the guide slots. The slightly raised portion initially moves the core plate away from the face and the wedge shaped portion forces the core plate into firm contact with the face when the moldset is substantially loaded into the machine. The face may be a face of a movable platen or a face of a hot runner.

As another example of such system, PCT patent application by Ciccone published on Sep. 30, 2004 and bearing a publication number WO 2004/082920 discloses a method of removing components of an injection mold machine, comprising a core assembly including a master core plate, a core plate releasably secured to said master core plate, said master core plate including guide means for guiding said core plate relative to said master core plate; a core insert secured to said core plate; a cavity assembly comprising a manifold plate, a first cavity plate releasably secured to the manifold plate, a cavity insert attached to the cavity plate, said cavity assembly moveable relative to the core assembly such that the cavity insert and core insert may be selectively mated together to define a cavity therebetween, said method comprising the steps of: (a) moving the core assembly and cavity assembly into a closed position whereat the cavity insert and core insert are mated together; (b) securing said core plate to said cavity plate, thereby forming a mold module; (c) releasing the securing means which secures the cavity plate to the manifold plate; (d) opening the mold from the closed position, until the first cavity plate disengages the manifold plate and all connections thereto, (e) releasing the securing means which secures the core plate to the master core plate; (f) lifting said mold module in a direction perpendicular to the direction of motion between said open and closed position, said module being guided in said perpendicular direction by said guide means.

### SUMMARY OF THE INVENTION

According to a first broad aspect of the present invention, there is provided an arrangement for guiding a mold set relative to a hot runner, the mold set including a cavity half and a core half, the mold set and the hot runner for use in a molding machine. The arrangement comprises a guiding member disposed on the hot runner; a guided member disposed on the cavity half; the guiding member and the guided member configured to cooperate to guide the mold set relative to the hot runner in a first direction and, sequentially, in a second direction, the second direction traversing the first direction.

According to a second broad aspect of the present invention, there is provided a hot runner. The hot runner comprises a base including a nozzle face, the base including a melt distribution network for distributing molten material towards the nozzle face; and a guiding member coupled substantially proximate and projecting beyond the nozzle face for guiding a cavity half of a mold set relative to the base in a first direction and, sequentially, in a second direction, the second direction traversing the first direction.

According to a third broad aspect of the present invention, there is provided a cavity half configured to be releasably latchable to a core half to form a mold set, the cavity half and the core half configured to define, in use, at least one molding cavity for receiving molten material and forming a molded article. The cavity half comprises a guided member configured to cooperate with a guiding member disposed on a hot runner, the guided member configured to guide the mold set relative to the hot runner in a first direction and, sequentially, in a second direction, the second direction traversing the first direction.

According to a fourth broad aspect of the present invention, there is provided a cavity half configured to be releasably latchable to a core half to form a mold set, the cavity half and the core half configured to define, in use, at least one molding cavity for receiving molten material and forming a molded article. The cavity half comprises first guiding means for effecting guiding the mold set relative to a hot runner in a first direction; second guiding means for effecting sequential guiding of the mold set relative to the hot runner in a second direction, the second direction traversing the first direction.

According to a fifth broad aspect of the present invention, there is provided a method of guiding a mold set relative to a hot runner, the mold set including a core half and a cavity half, the cavity half and the core half configured to define, in use, at least one molding cavity for receiving molten material and forming a molded article. The method comprises guiding the cavity half of the mold set relative to the hot runner in a first direction; and once a fully-loaded position in the first direction is reached, guiding the cavity half of the mold set relative to the hot runner in a second direction, the second direction traversing the first direction.

According to another broad aspect of the present invention, there is provided a mold stack. The mold stack comprises a hot runner operatively coupled, in use, to a source of molten material, the hot runner further including a guiding member; a mold set including a core half and a cavity half, the cavity half and the core half configured to define, in use, at least one molding cavity for receiving, in use, molten material from the hot runner for forming a molded article; the cavity half further including a guided member; the guiding member and the guided member configured to cooperate to guide the mold set relative to the hot runner in a first direction and, sequentially, in a second direction, the second direction traversing the first direction.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a side view of a mold stack 100 including a mold set 108 and a hot runner 102 implemented according to a non-limiting embodiment of the present invention.

FIG. 2 depicts a side view of the mold set 108 of FIG. 1 during a first and a second portions of a sequence of guiding the mold set 108 relative to the hot runner 102.

FIG. 3 depicts a side view of the mold set 108 of FIG. 1 during a third and a fourth portions of a sequence of guiding the mold set 108 relative to the hot runner 102.

FIG. 4 depicts a side view of the mold set 108 of FIG. 1 during a fifth and a sixths portions of a sequence of guiding the mold set 108 relative to the hot runner 102.

FIG. 5 depicts a side view of a mold stack 500, the mold stack 500 including a mold set 108 and a hot runner 102 implemented according to a non-limiting embodiment of the present invention, the mold stack 500 being of a single level type.

FIG. 6 depicts a side view of a mold stack 600, the mold stack 600 including three instances of a mold set 108 and three instances of a hot runner 102 implemented according to a non-limiting embodiment of the present invention, the mold stack 600 being of a three-level type.

FIG. 7 depicts a side view of a mold stack 700, the mold stack 700 including four instances of a mold set 108 and four instances of a hot runner 102 implemented according to a non-limiting embodiment of the present invention, the mold stack 600 being of a four-level type.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

Embodiments of the present invention have been developed as a result of inventors' appreciation of certain problems associated with known solutions. Broadly speaking, inventors have appreciated that known quick mold change solutions can be categorized as (a) solutions that rely, at least partially, on guiding means disposed on a machine element (such as, for example, a platen) for guiding at least some of the mold sets into the molding machine, or (b) rely on separate platen-mountable support plates for guiding mold sets into the molding machine. Inventors have further appreciated that solutions of the first type suffer from the fact that modifications are necessary to a standard molding machine and, as such, mold sets within these solutions can not be easily installed into the standard molding machine. Similarly, inventors have appreciated that solutions of the second type are suffering from increased shut size, as well as increased machine size requirements and, therefore, require more operational real estate.

Inventors have further appreciated that presently used solutions rely, at least in part, on aligning a core half of a mold set relative to a non-nozzle face of a hot runner or a platen. This, in turn, potentially leads to mis-alignment of the core half relative to a cavity half (which also needs to be aligned to nozzles of the hot runner) and, as a result, to increased premature wear.

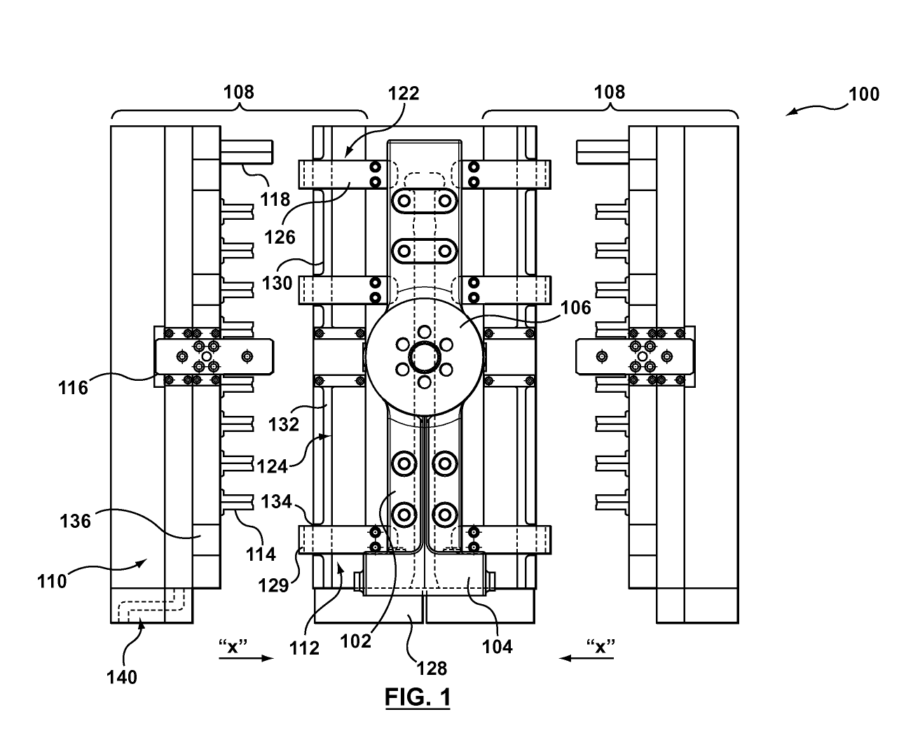

With reference to FIG. 1, a portion of a mold stack 100 implemented according to a non-limiting embodiment of the present invention is depicted. FIG. 1 depicts the mold stack 100 in a fully assembled configuration and in the mold open position, but FIG. 1 omits, for the sake of simplicity, the clamp and other components of the molding machine. Also, some commonly known and used components of the mold stack 100 have been omitted from the illustration for the sake of simplicity. Within the illustration of this embodiment of the preset invention, the mold stack 100 is a two-level stack mold. However, as will be discussed herein below, teachings of the present invention are not so-limited.

The mold stack 100 comprises a hot runner 102. The hot runner 102 is operatively fluidly connectable, in use, to a source of molten material (not depicted) and comprises an internal distribution network (not depicted) for conveying and distributing the molten material. The hot runner 102 is mountable onto a machine carrier 104, which is configured for attachment to a portion of a molding machine (not depicted), by means of, for example, linear bearings or other suitable means. The machine carrier 104 comprises a linkage interface 106 for accepting, in use, a linkage mechanism (not depicted) which is configured to actuate the machine carrier 104. Arrangements of such linkage mechanisms (not depicted) are known to those of skill in the art and, as such, will not be discussed here at any length. Recalling that the mold stack 100 is of the two-level stack mold type, the mold stack 100 comprises two instances of the hot runner 102, which can be implemented as two hot runner plates bolted together and the like.

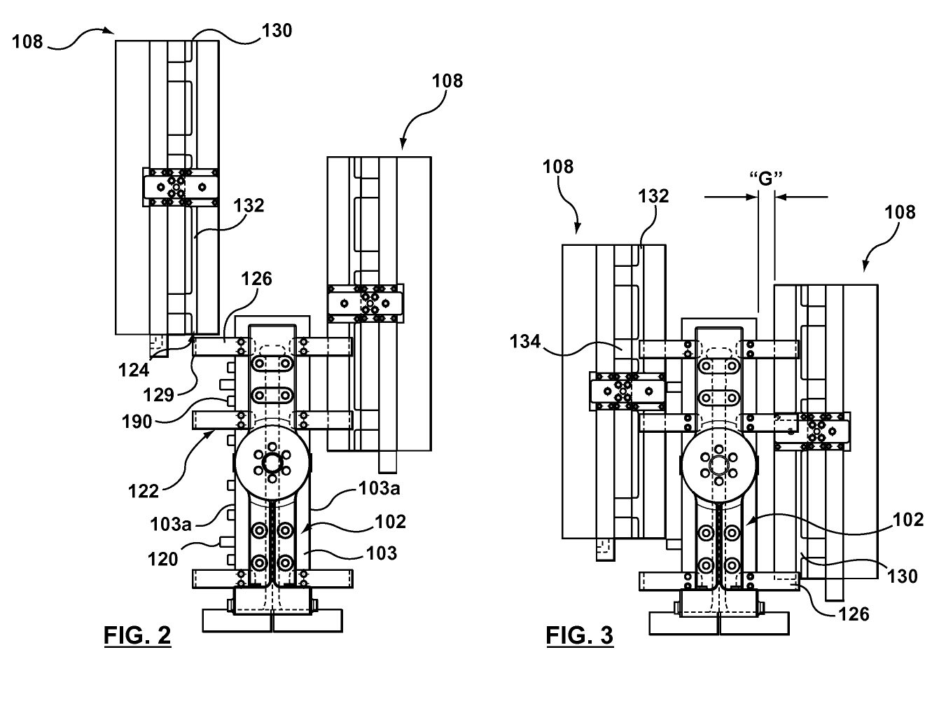

With brief reference to FIG. 2, each of the two instances of the hot runner 102 comprises a base 103. The base 103 comprises a nozzle face 103a. The nozzle face 103a is a portion of the base 103 where one or more nozzles 190 (some of which are schematically depicted in FIG. 2) are mounted and that faces, in use, the mold set 108. Accordingly, it can be said that the internal distribution network (not depicted) is configured to convey the molten material towards the nozzle face 103a of the base 103 and, more specifically, towards the one or more nozzles 190 mounted on the nozzle face 103a.

Returning to the description of FIG. 1, the mold stack 100 further comprises a mold set 108. Recalling that the mold stack 100 is of a two-level stack mold type, the mold stack 100 comprises two instances of the mold set 108, each located at opposing sides of the machine carrier 104 and abutting a respective instance of the hot runner 102. For brevity of description, only a single instance of the mold set 108 will be described herein below. However, the description to be presented below equally applies to the other instance of the mold set 108 other than for certain differences, such as direction of movement, etc.

The mold set 108 comprises a core half 110 and a cavity half 112. The core half 110 comprises a plurality of cores 114, which can be implemented as core inserts or as integrally made members. The cavity half 112 comprises a plurality of cavity members (not depicted) and gate members (not depicted), which are complementary in shape to the plurality of cores 114 for defining, therebetween, a plurality of molding cavities for forming molded articles therein. The plurality of cavity members and gate members (not depicted) can be implemented as cavity inserts and gate inserts, respectively, or can be integrally made within the cavity half 112. In those embodiments where the plurality of cavity members and gate members are implemented as inserts, these can be implemented as separate inserts (i.e. a separate cavity insert and a separate gate insert) or as structurally integral members.

The plurality of gate members (not depicted) is fluidly operatively coupled to the aforementioned internal distribution network (not depicted) via one or more nozzles 190 for receiving molten material. Furthermore, even though not shown in FIG. 1, at least one of the two instances of the mold sets 108 can be associated with a cut-out (not depicted) for allowing a sprue of the molding machine (not depicted) to pass therethrough for supplying molten material to the hot runner 102. Several other components of the mold stack 100 (such as, for example, ejection structures, cooling structures, etc) have been omitted from illustration for the sake of simplicity.

Within the specific non-limiting example being presented herein, the plurality of cores 114 and the plurality of cavity members and gate members (not depicted) are configured for producing molded articles in a form of thin-wall containers, such as for example, beverage cups. However, it should be expressly understood that teachings of embodiments of the present invention are not limited to mold sets 108 for production of thin-wall containers and/or beverage cups. Quite on the contrary, embodiments of the present invention can be implemented in mold sets 108 configured for production of other thin-wall containers, preforms suitable for blow-molding into final shaped containers, closures and other molded articles. It is expected that those of skill in the art will be able to modify structure of the mold set 108 to suit other implementations. For example, in those embodiments of the present invention where the mold set 108 is configured for producing preforms, the mold set 108 can additionally include split mold inserts (not depicted), commonly known as neck rings. Similarly, even though embodiments of the present invention are described herein with the mold set 1098 configured with multi-cavity molds, this not need be so in every embodiment of the present invention and those skilled in the art will be able to modify teachings presented herein to a single-cavity implementation, if need be.

It should be further noted that even though the cross-section of the molded article produced within the mold set 108 is substantially circular, this need not be so in every embodiment of the present invention. Furthermore, even though within this specific example, each of the mold sets 108 is configured to produce substantially similar molded articles, this need not be so in every embodiment of the present invention. Accordingly, within alternative non-limiting embodiments of the present invention, each or some of the mold sets 108 present within the mold stack 100 can be configured to produce different types of molded articles.

Continuing with description of the non-limiting embodiment of FIG. 1, the core half 110 further comprises a leader pin 118 and the cavity half 112 comprises complementary leader bushing (not depicted). The leader pin 118 and the complementary leader bushing (not depicted) cooperate to effect alignment of the core half 110 vis-à-vis the cavity half 112. Similarly, the hot runner 102 comprises guide pins 120 (shown in FIG. 2) and the cavity half 112 comprises a complementary guide bushings (not depicted). The guide pins 120 and the complementary guide bushings cooperate to effect alignment of the cavity half 112 vis-à-vis the hot runner 102.

According to embodiments of the present invention, the hot runner 102 comprises a guiding member 122 and the cavity half 112 comprises a guided member 124. The guiding member 122 and the guided member 124 are configured to cooperate, in use, to guide the mold set 108 relative to the hot runner 102 for the purposes of installing the mold set 108 onto the hot runner 102. This can be particularly useful when it is required to change the mold set 108 for another mold set 108 (for example, the other mold set 108 being of different configuration) or when it is required to remove the mold set 108 for servicing and subsequently replace it.

Within a specific non-limiting embodiment of present invention, the guiding member 122 can comprise a set of three guide bars 126 coupled to the hot runner 102 (by means of a suitable fastener, such as bolts and the like) and a stop member 128 coupled to the hot runner 102 (by a suitable fastener, such as bolts and the like). It should be noted that the guiding member 122 is associated with the nozzle face 103a (FIG. 2) of the hot runner 102. More specifically, each of the set of three guide bars 126 is coupled substantially proximate to the nozzle face 103a of the hot runner 102 and generally project beyond and therefrom in a direction towards the mold set 108. For ease of reference, a given one of the set of three guide bars 126 will be referred to herein below as a top-most instance of the guide bar 126, a second top-most instance of the guide bar 126 and the bottom-most instance of the guide bar 126, denoting their respective vertical position as viewed in FIG. 1.

Naturally, as the presently described embodiment contemplates the mold stack 100 being of two-level stack mold type, an instance of the set of three guide bars 126 and the stop member 128 is provided on each side of the hot runner 102.

The guided member 124 can comprise a slot 130 defined within a side of the cavity half 112. Each of the set of three guide bars 126 comprises a protruding guide 129. The protruding guide 129 is dimensioned such that to slide within the slot 130.

The slot 130 comprises a vertical portion 132 and three instances of a horizontal portion 134. The vertical portion 132 of the slot 130 is defined in an outmost portion of the cavity half 112 relative to the hot runner 102. This arrangement allows for a gap “G” (showed in FIG. 3) to be defined between the hot runner 102 and the mold set 108, when the protruding guide 129 is engaged within the vertical portion 132 of the slot 130. This, in turn, provides sufficient clearance for the guide pins 120 (FIG. 2) and one or more nozzles 190 (FIG. 2) associated with the hot runner 102 during the process of guiding the mold set 108 onto the hot runner 102 (or when the mold set 108 is being removed from the hot runner 102), as will be discussed in greater detail herein below.

Position of each of the three instances of the horizontal portion 134 corresponds to position of each of the set of three guide bars 126 when the mold set 108 is in a fully-loaded vertical position relative to the hot runner 102. It can be seen from the illustration in FIG. 1 that each of the set of three guide bars 126 is dimensioned to project beyond the nozzle face 103a of the hot runner 102 by a projecting length that exceeds a thickness associated with the cavity half 112. More specifically, the projecting length of each of the set of three guide bars 126 is so dimensioned as to provide for thickness of the cavity half 112 and the gap “G” (FIG. 3).

It can be said that the three instances of horizontal portion 134 cooperate with the set of three guide bars 126 to allow the mold set 108 to move in a direction depicted in FIG. 1 at “X”, which is right-bound for the left mold set 108 and left-bound for the right mold set 108 (as will be explained in greater detail herein below), when the mold set 108 is in the fully-loaded vertical position.

Accordingly, it can be said that the guiding member 122 and the guided member 124 are configured to cooperate, in use, to guide the mold set 108 relative to the hot runner 102 in a first direction and then, sequentially, in a second direction, the second direction traversing the first direction. Within the embodiment being presented herein, the first direction is substantially vertical and the second direction is substantially horizontal and, accordingly, the first direction and the second direction can be substantially perpendicular relative each other.

Furthermore, the set of three guide bars 126 can be said to be configured to cooperate with the vertical portion 132 to effect guiding in the first direction and the set of three guide bars 126 can be said to be configured to cooperate with the three instances of a horizontal portion 134 to effect guiding in the second direction. It can be also said that the guided member 124 on the cavity half 112 comprises first guiding means for effecting guiding in the first direction (i.e. the vertical portion 132) and second guiding means for effecting guiding in the second direction (i.e. the three instances of a horizontal portion 134).

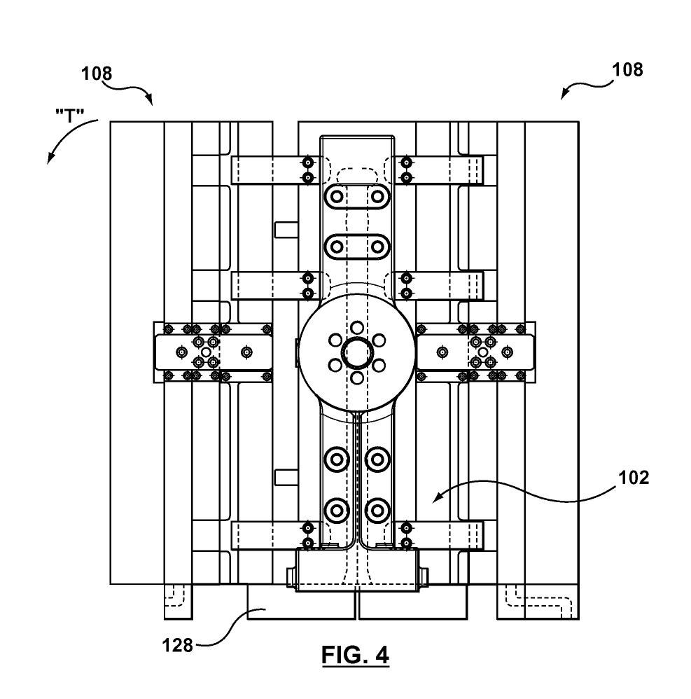

The core half 110 can also include a set of three horizontal slots 136. Position of each of the set of three horizontal slots 136 corresponds to position of each of the set of three guide bars 126 when the mold set 108 is in a fully-loaded vertical position relative to the hot runner 102. Accordingly, it can be said that the set of three horizontal slots 136 is configured to accommodate a portion of each of the set of three guide bars 126 in the mold closed position (for example, see FIG. 4 which shows, on the right-hand side, the mold closed configuration). Each of the three instances of the horizontal portion 134 and each of the set of three horizontal slots 136 are so configured to allow passage therethough of the respective one of the of three guide bars 126.

The stop member 128 is coupled to the lowermost portion of the hot runner 102 by suitable fasteners, such as bolts and the like. The stop member 128 is configured to denote the lowermost position when guiding the mold set 108 relative to the hot runner 102 or, in other words, a position where the mold set 108 is fully loaded onto the hot runner 102 as far as vertical displacement is concerned.

The stop member 128 is made of material with sufficiently high co-efficient of friction to prevent tipping of the mold set 108 (as will be described in greater detail herein below), but low enough to allow sliding of the mold set 108 in the direction “X”. An example of such material is machined steel with no grease or other frictionless material applied thereto. In alternative non-limiting embodiments of the present invention, the stop member 128 can be made longer or, put another way, dimensioned such that to prevent tipping and, within those embodiments, selection consideration of co-efficient of friction of material used for the stop member 128 can be given exclusively to sliding of the mold set 108 relative to the stop member 128.

The mold set 108 further comprises a coupling 116 configured to releasably latch the core half 110 to the cavity half 112. Within the specific non-limiting embodiment of the present invention, the coupling 116 is depicted as being associated with the core half 116. However, this need not be so in every embodiment of the present invention and, as such, the coupling 116 can be associated with the cavity half 112 or it can be attached to both the cavity half 112 and the core half 116 only at an appropriate time (as will be described in greater detail herein below). The coupling 116 can be attached to the core half 116 and/or to the cavity half 112 by means of bolts or other suitable selectively releasable fasteners.

The coupling 116 is positioned in a recess (not separately numbered) defined, respectively, within the core half 110 and the cavity half 112. The recess (not separately numbered) is dimensioned in a manner such that when the coupling 116 (and the associated fasteners) are positioned within the recess (not separately numbered), no interference is created for the sliding of the protruding guide 129 during sliding of the protruding guide 129 over this area during an appropriate portion of a sequence for guiding the mold set 108 relative to the hot runner 102 (as will be described in greater detail herein below).

To complete description of the embodiment of FIG. 1, the mold set 108 further comprises a service coupling 140, which is configured to operatively couple services (such as, for example, a source of coolant, source of over or under pressure supply and the like) to the mold set 108, when the mold set 108 is fully loaded onto the machine carrier 104 and the respective platens (not depicted). The service coupling 140 comprises two portions (not separately numbered)—one associated with the mold set 108 and one associated with the molding machine (not depicted). Implementation of such service coupling 140 is known to those skilled in the art. An example of one such service coupling 140 can be implemented as described in the co-owned US patent application 2006/0083803 to DiSimone published on Apr. 20, 2006, content of which is incorporated herein by reference in its entirety.

Now, given the architecture described herein above with reference to FIG. 1, it is possible to execute a method of guiding a mold set 108 relative to the hot runner 102. The sequence of steps will be described with reference to FIGS. 2, 3 and 4. For brevity of illustration, each of the two mold sets 108 in a given illustration is shown at different stages of the sequence. It should be expressly understood that, in use, the sequence may be implemented for one of the mold sets 108 at a time or the sequence may be executed in parallel. For ease of referral, each of the mold sets 108 will be referred to as either “left” or “right” denoting their appearance within the illustration relative to the hot runner 102.

For the purposes of description to be presented herein below, it shall be assumed that the hot runner 102 is positioned within a molding machine (not depicted). Furthermore, it shall be further assumed that the clamp (not depicted) has been actuated into a mold open configuration.

The core half 110 and the cavity half 112 are first latched together, for example, by means of the coupling 116. This can be implemented, for example, by securing bolts or other suitable fasteners. The aforementioned leader pin 118 and the complementary leader bushing (not depicted) are used to effect alignment of the core half 110 vis-à-vis the cavity half 112.

With reference to FIG. 2 (which depicts a first and a second portion of the sequence of guiding the mold set 108 relative to the hot runner 102) and, in particular, the left mold set 108, the mold set 108 is first positioned above the hot runner 102. The mold set 108 can be positioned above the hot runner 102 using a crane (not depicted) or other suitable means.

Next, the top-most instance of the guide bar 126 is aligned with the slot 130. More specifically, the protruding guide 129 is aligned with the vertical portion 132 of the slot 130. This can be implemented, for example, by means of an operator manually guiding the mold set 108 to affect alignment of the guide bar 126 and the slot 130. Once this alignment is achieved, the mold set 108 is lowered onto the hot runner 102.

The right mold set 108 in FIG. 2, depicts the next portion of the sequence of guiding the mold set 108 relative the hot runner 102, as the lowering of the mold set 108 progresses. As the lowering of the mold set 108 progresses, the vertical portion 132 slides along the top-most instance of the guide bar 126. As the lowering progresses further, a second top-most instance of the guide bar 126 engages the slot 130 (as shown on the right-hand side of FIG. 2).

FIG. 3 depicts a third and a fourth portions of the sequence of guiding the mold set 108 relative to the hot runner 102. More specifically, the left-hand side illustration and the right-hand side illustrations in FIG. 3 show the progression of guiding of the mold set 108. It is worthwhile noting within the left-hand side illustration in FIG. 3 that the top-most instance of the guide bar 126 and the second top-most instance of the guide bar 126 are associated with a vertical displacement selected such that when the top-most instance of the guide bar 126 is aligned with an instance of a horizontal portion 134 of the slot 130, the second top-most instance of the guide bar 126 is still aligned within the vertical portion 132 to prevent any substantial horizontal displacement of the mold set 108. The right-hand side illustration of FIG. 3 shows progression of the sequence of guiding where the bottom-most instance of the guide bar 126 engages the slot 130.

FIG. 4 shows a fifth and a sixths portions of the sequence of guiding the mold set 108 relative to the hot runner 102 and, more specifically, further progression of the guiding of the mold set 108 onto the hot runner 102. The left-hand side illustration of FIG. 4 shows a portion of guiding where a portion of the mold set 108 engages the stop member 128, which denotes the fact that the mold set 108 has reached its fully-loaded position as far as vertical displacement is concerned. It is worthwhile recalling that the stop member 128 can be made from material with sufficiently high co-efficient of friction to prevent tipping of the mold set 108. It is in this position where this becomes important from preventing the mold set 108 from tipping in a direction depicted in FIG. 4 at “T”. In an alternative embodiment, as has been previously described, the stop member 128 can be extended in a horizontal direction to prevent this tipping.

It should be noted that portions of guiding sequence described above can be said to denote steps associated with guiding of the mold set 108 in a first direction, which in this case is a vertical direction.

Now that the mold set 108 has reached its fully-loaded position as far as vertical displacement is concerned, the mold set 108 is actuated in a horizontal direction (depicted at “X” in FIG. 1). At this point, guiding in a second direction commences, which in the case being depicted herein is horizontal. At this stage, the mold set 108 can be disengaged from the crane or other means used for loading the mold set 108. The actuation of the mold set 108 in the horizontal direction can be achieved, for example, by actuating the clamp (not shown) into the mold closed position. As the clamp (not depicted) moves into the mold closed position, the guide pins 120 and the complementary guide bushings are relied upon to effect alignment of the cavity half 112 (and, therefore, the mold set 108) vis-à-vis the hot runner 102.

Once the clamp (not depicted) has reached the mold closed position (right-hand side illustration in FIG. 4), each of the instances of the core half 110 is at least partially secured to a respective platen (not depicted). This can be executed by means of securing at least some of the bolts (not depicted) that can be accessible via clamp slots (not depicted). It can be said that, at this point, the core half 110 is positively located relative to a respective platen (not depicted) that ensures proper alignment between portions of the mold set 108 and substantially prevents increased premature wear to the portions of the mold set 108. Similarly, each of the instances of the cavity half 112 is at least partially secured to the hot runner 102. This can be implemented by means of securing cavity latches (not depicted).

It is worthwhile noting that at this stage the service coupling 140 also operatively couples services (such as, for example, a source of coolant, source of over or under pressure supply and the like) to the mold set 108.

Next, the coupling 116 is disengaged or, in other words, the core half 110 is unlatched from the cavity half 112. This can be executed by means of undoing bolts associated with either one of the core half 110 or the cavity half 112 or, alternatively, completely removing the coupling 116 from both the core half 110 and the cavity half 112.

Next, the clamp (not depicted) is actuated into a mold open position. Next, the core half 110 and the cavity half 112 are fully secured to the respective platen (not depicted) and the hot runner 102, respectively. This can be implemented, by securing the remaining bolts in case of the core half 110 and securing bolts in case of the cavity half 112.

At this stage, the mold set 108 has been aligned with the hot runner 102 (as is shown in FIG. 1) and fully secured to the molding machine (not depicted). Should it be desirable to replace the mold set 108 with another mold set 108 at a subsequent point in time, the steps described above with reference to FIGS. 2, 3 and 4 are first repeated in reverse to remove the mold sets 108 from the mold stack 100 and then repeated again in the order described above to guide another mold set 108 onto the mold stack 100.

Now, even though the embodiment of FIG. 1 has been described with set of three guide bars 126, three instances of a horizontal portion 134 and the set of three horizontal slots 136; this need not be so in every embodiment of the present invention. It is contemplated that alternative non-limiting embodiments of the present invention can be implemented with only a single instance of each of the guide bar 126, the horizontal portion 134 and the horizontal slot 136. This single instance can be located at a respective top-most portion of the mold set 108. Those skilled in the art will appreciated that special care will need to be taken when lowering the mold set 108 in this alternative non-limiting embodiment compared to the embodiment depicted in FIG. 1. Accordingly, it can be said that embodiments of the present invention provide a guiding member 122 and the guided member 124 implemented as at least one guide bar 126 and the slot 130, which includes at least one horizontal portion 134. Also, there is provided at least one horizontal slot 136.

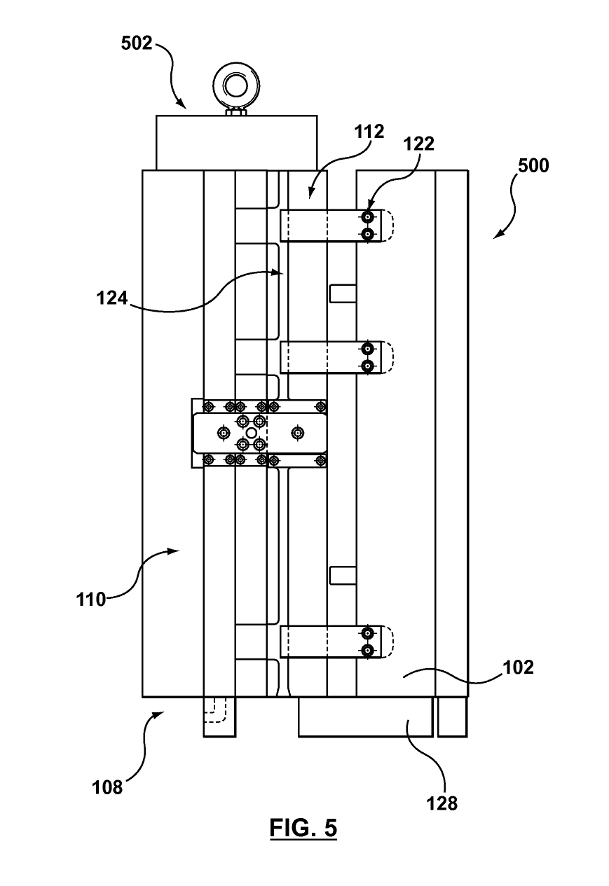

Even though FIG. 1 depicts the mold stack 100 of the two-level mold stack type, this not need be so in every embodiment of the present invention. For example, in an alternative non-limiting implementation, teachings of the embodiments of the present invention can be applied to a single-level mold stack for implementing a quick-change solution to installing a single instance of the mold set 108 relative to the hot runner 102. An example of such an implementation is depicted in FIG. 5, which shows a mold stack 500. The mold stack 500 is substantially similar to the mold stack 100, other than the mold stack 500 is of a single-level type. The mold stack 500 includes the hot runner 102, the core half 110 and the cavity half 112, all implemented substantially similar to the implementation that was described in reference to FIG. 1. The guiding member 122 and the guided member 124 are also provided for guiding the mold set 108 relative to the hot runner 102. Of interest, FIG. 5 further illustrates an actuator coupling 502 for coupling the mold set 108 to the aforementioned crane (not depicted) or another suitable means. The actuator coupling 502 can be detachably coupled to the mold set 108 (for example, by means of bolts and the like) or permanently attachable to one of the core half 110 or the cavity half 112.

It is worthwhile noting that since the mold stack 500 of FIG. 5 is of the single-level type, the mold stack 500 does not include a component similar to the machine carrier 104.

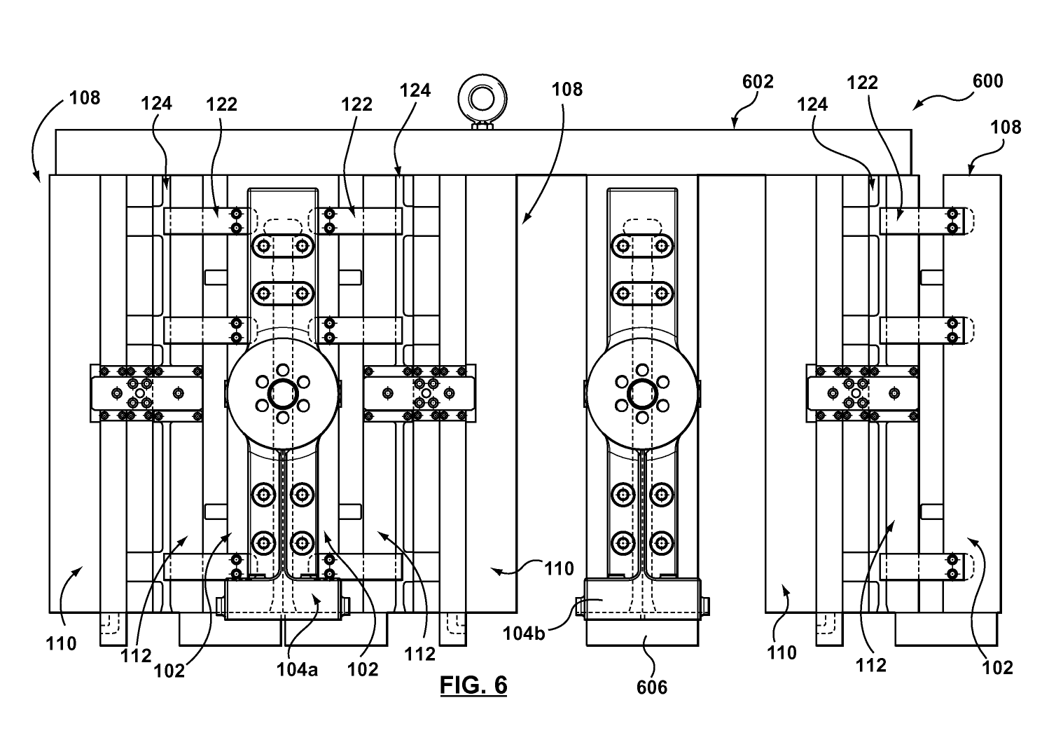

In yet other implementations of the embodiments of the present invention, teachings of the embodiments of present invention can be applied to three- or four-level stack molds. For example, with reference to FIG. 6, another non-limiting embodiment of the present invention is depicted. FIG. 6 depicts a mold stack 600, implemented according to another non-limiting embodiment of the present invention. The mold stack 600 is substantially similar to the mold stack 500, other than the mold stack 600 is of a three-level type. To that extent, the mold stack 600 includes three instances of the hot runner 102, three instances of the core half 110 and three instances of the cavity half 112, all implemented substantially similar to the implementation that was described in reference to FIG. 1.

It is worthwhile noting that within the embodiment of FIG. 6, there are provided two instances of machine carrier 104—a first machine carrier 104a and a second machine carrier 104b. The first machine carrier 104a is associated with the hot runner 102 (or, in fact, with two instances of the hot runner 102), while the second machine carrier 104b is not associated with the hot runner 102, as the second machine carrier 104b is configured for attachment to a respective core half 110. The second machine carrier 104b further comprises a service connection 606 for coupling services to the respective core halves 110 mounted onto the second machine carrier 104b. It is also worthwhile noting that FIG. 6 does not depict an arrangement of conduits for distributing molten material to each instance of the hot runner 102, however, these arrangements are known to those if skill in the art and, as such, will not be described here for the sake of brevity.

Also provided are three instances of each of the guiding member 122 and the guided member 124 for guiding a respective mold set 108 relative to a respective hot runner 102. Of interest, FIG. 6 further illustrates an actuator coupling 602 for simultaneous coupling of all instances of the mold set 108 to the aforementioned crane (not depicted) or another suitable means. In alternative non-limiting embodiments of the present invention, however, a separate instance of the actuator coupling 602 can be used for each of the instances of the mold set 108, similar to the embodiment depicted in FIG. 5.

It is worthwhile noting that the method for guiding the mold set 108 in the mold stack 600 can be implemented substantially similar to what has been described above. One marked difference is that during the aforementioned steps where the core half 110 is either fully secured or partially secured, within the embodiment depicted in FIG. 6, (a) some of the core halves 110 are secured to a respective platen, and (b) some of the core halves 110 are secured to the second machine carrier 104b.

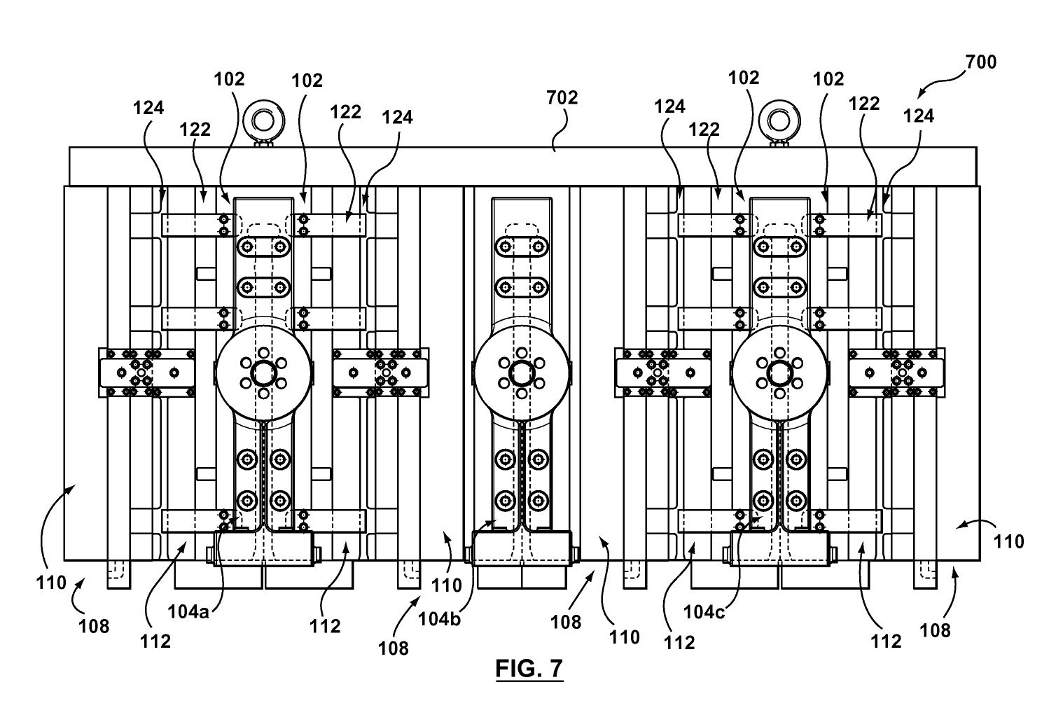

As a further example, with reference to FIG. 7, another non-limiting embodiment of the present invention is depicted. FIG. 7 depicts a mold stack 700, implemented according to another non-limiting embodiment of the present invention. The mold stack 700 is substantially similar to the mold stack 600, other than the mold stack 700 is of a four-level type. To that extent, the mold stack 700 includes four instances of the hot runner 102, four instances of the core half 110 and four instances of the cavity half 112, all implemented substantially similar to the implementation that was described in reference to FIG. 1.

It is worthwhile noting that within the embodiment of FIG. 7, there are provided three instances of machine carrier 104—a first machine carrier 104a, a second machine carrier 104b and a third machine carrier 104c. The first machine carrier 104a and the third machine carrier 104c are associated with a respective instance of the hot runner 102, while the second machine carrier 104b is not associated with the hot runner 102, as the second machine carrier 104b is configured for attachment to a respective core half 110. It is also worthwhile noting that FIG. 7 does not depict an arrangement of conduits for distributing molten material to each instance of the hot runner 102, however, these arrangements are known to those if skill in the art and, as such, will not be described here for the sake of brevity.

Also provided are four instances of each of the guiding member 122 and the guided member 124 for guiding a respective mold set 108 relative to a respective hot runner 102. FIG. 7 further illustrates an actuator coupling 702 for simultaneous coupling of all instances of the mold set 108 to the aforementioned crane (not depicted) or another suitable means. In alternative non-limiting embodiments of the present invention, however, a separate instance of the actuator coupling 702 can be used for each of the instances of the mold set 108, similar to the embodiment depicted in FIG. 5.

It is worthwhile noting that the method for guiding the mold set 108 in the mold stack 700 can be implemented substantially similar to what has been described above. One marked difference is that during the aforementioned steps where the core half 110 is either fully secured or partially secured, within the embodiment depicted in FIG. 7, (a) some of the core halves 110 are secured to a respective platen, and (b) some of the core halves 110 are secured to the second machine carrier 104b.

Even though embodiments of the present invention have been described above with reference to the guiding member 122 disposed on the hot runner 102 including at least one guide bar 126 and the guided member 124 including the slot 130 defined within the cavity half 112, in alternative non-limiting embodiments of the present invention, these may be reversed. Put another way, within those alternative non-limiting embodiments of the present invention, the guiding member 122 disposed on the hot runner 102 can be implemented as the slot 130 defined within a side of the hot runner 102 and the guided member 124 can be implemented as at least one guide bar 126 attached to the cavity half 112.

Furthermore, even though embodiments of the present invention have been described above with reference to the guiding member 122 disposed on the hot runner 102 including at least one guide bar 126 and the guided member 124 including the slot 130 defined within the cavity half 112, in alternative non-limiting embodiments of the present invention, the guiding member 122 and the guided member 124 may be implemented differently and may have a different form factor. For example, it is contemplated that in an alternative non-limiting embodiment of the present invention, the guiding member 122 may be implemented as a cam track and the guided member 124 can be implemented as a cam follower or vice versa. Yet other form factor implementation will become apparent to those of skill in the art having regard to teachings of non-limiting embodiments of the present invention.

A technical effect of embodiments of the present invention involves provision of an arrangement for guiding a mold set 108 relative to the hot runner 102 which does not require any machine modifications and, therefore, can be used with a standard molding machine (not depicted). Another technical effect of embodiments of the present invention is provision of an arrangement for guiding the mold set 108 relative to the hot runner 102 which does require additions of support plates and, therefore, does not negatively impact the shut size. This, in turn, results in ability to use a smaller size of a clamp and, additionally or alternatively, lower costs as compared to support plate based solutions. Naturally, it should be expressly understood that not each and every technical effect needs to be enjoyed in its entirety in each and every embodiment of the present invention.

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described. Therefore, what is to be protected by way of letters patent are limited only by the scope of the following claims:

What is claimed is:

1. An arrangement for guiding a mold set relative to a hot runner, the mold set including a cavity half and a core half, the mold set and the hot runner for use in a molding machine, the arrangement comprising:
a guiding member disposed on the hot runner;
a guided member disposed on the cavity half;
the guiding member and the guided member configured to cooperate to guide the mold set relative to the hot runner in a first direction and, sequentially, in a second direction, the second direction traversing the first direction.

2. The arrangement of claim 1, wherein
said guiding member comprises at least one guide bar; and wherein
said guided member comprises a slot defined in a side of said cavity half, the slot comprising a vertical portion and at least one horizontal portion; and wherein
said at least one guide bar cooperates with said vertical portion to effect guiding in the first direction; and
said at least one guide bar cooperates with said at least one horizontal portion to effect guiding in the second direction.

3. The arrangement of claim 2, wherein said at least one guide bar comprises a set of three guide bars and wherein said at least one horizontal portion comprises three instances of horizontal portion.

4. The arrangement of claim 3, wherein a top-most instance of the guide bar and a second top-most instance of the guide bar 126 are associated with a displacement in the first direction selected such that when the top-most instance of the guide bar is aligned with an instance of the horizontal portion, the second top-most instance of the guide bar is aligned within the vertical portion such that to prevent any substantial displacement of the mold set in the second direction during guiding in the first direction.

5. The arrangement of claim 2, wherein
said guiding member further comprises a stop member coupled to the hot runner, the stop member configured to denote a fully-loaded configuration in the first direction.

6. The arrangement of claim 5, wherein said stop member is designed from a material having a co-efficient of friction so selected such that to (a) prevent tipping of the mold set when resting in a fully-loaded position in the first direction; and (b) allow sliding of the mold set in the second direction.

7. The arrangement of claim 5, wherein said stop member is dimensioned such that to prevent tipping of the mold set when resting in a fully-loaded position in the first direction and designed from a material having a co-efficient of friction so selected such that to allow sliding of the mold set in the second direction.

8. The arrangement of claim 2, wherein said at least one guide bar is operatively attached to and projects beyond a nozzle face of the hot runner, and wherein the at least one guide bar is so dimensioned as to provide, in cooperation with the vertical portion, for a gap between the mold set and the hot runner during a portion of a guiding sequence in the first direction.

9. The arrangement of claim 2, wherein the core half comprises at least one horizontal slot to accommodate a portion of the at least one guide bar in a mold closed configuration.

10. The arrangement of claim 2, wherein said at least one guide bar comprises at least one protruding guide, said at least one protruding guide dimensioned so that to slide along said vertical portion and through said at least one horizontal portion.

11. The arrangement of claim 1, wherein
said guiding member comprises a slot defined in a side of said hot runner, the slot comprising a vertical portion and at least one horizontal portion; and wherein
said guided member comprises at least one guide bar attached to said cavity half; and wherein
said at least one guide bar cooperates with said vertical portion to effect guiding in the first direction; and
said at least one guide bar cooperates with said at least one horizontal portion to effect guiding in the second direction.

12. The arrangement of claim 1, wherein
said guiding member comprises one of a cam track and a cam follower; and wherein
said guided member comprises the other one of the cam track and the cam follower.

13. A hot runner comprising:
a base including a nozzle face, the base including a melt distribution network for distributing molten material towards the nozzle face; and
a guiding member coupled substantially proximate and projecting beyond the nozzle face for guiding a cavity half of a mold set relative to the base in a first direction and, sequentially, in a second direction, the second direction traversing the first direction.

14. The hot runner of claim 13, wherein said guiding member comprises at least one guide bar.

15. The hot runner of claim 14, wherein the at least one guide bar is so dimensioned as to provide, in cooperation with a guided member associated with the cavity half, for a gap between the mold set and a hot runner during a portion of a guiding sequence in the first direction.

16. A cavity half configured to be releasably latchable to a core half to form a mold set, the cavity half and the core half configured to define, in use, at least one molding cavity for receiving molten material and forming a molded article; the cavity half comprising:
a guided member configured to cooperate with a guiding member disposed on a hot runner, the guided member configured to guide the mold set relative to the hot runner in a first direction and, sequentially, in a second direction, the second direction traversing the first direction.

17. The cavity half of claim 16, wherein
said guided member comprises a slot defined in a side of said cavity half, the slot comprising a vertical portion and at least one horizontal portion; and wherein
said vertical portion is configured to cooperate with the guiding member to effect guiding in the first direction; and
said at least one horizontal portion is configured to cooperate with the guiding member to effect guiding in the second direction.

18. A cavity half configured to be releasably latchable to a core half to form a mold set, the cavity half and the core half configured to define, in use, at least one molding cavity for receiving molten material and forming a molded article; the cavity half comprising:
first guiding means for effecting guiding the mold set relative to a hot runner in a first direction;
second guiding means for effecting sequential guiding of the mold set relative to the hot runner in a second direction, the second direction traversing the first direction.

19. A method of guiding a mold set relative to a hot runner, the mold set including a core half and a cavity half, the cavity half and the core half configured to define, in use, at least one molding cavity for receiving molten material and forming a molded article, the method comprising:
guiding the cavity half of the mold set relative to the hot runner in a first direction;
once a fully-loaded position in the first direction is reached, guiding the cavity half of the mold set relative to the hot runner in a second direction, the second direction traversing the first direction.

20. The method of claim 19, wherein said guiding the cavity half of the mold set relative to the hot runner in a first direction comprises:
first, latching the core half and the cavity half to form the mold set.

21. The method of claim 20, wherein said guiding the cavity half of the mold set relative to the hot runner in a first direction further comprises:
after said latching, positioning the mold set over the hot runner.

22. The method of claim 21, wherein said guiding the cavity half of the mold set relative to the hot runner in a first direction further comprises:
after said positioning, aligning a guiding member with a guided member.

23. The method of claim 22, wherein said guiding the cavity half of the mold set relative to the hot runner in a first direction further comprises:
after said aligning, using the guiding member and the guided member to guide the mold set during guiding of the mold set in the first direction.

24. The method of claim 19, wherein said guiding the cavity half of the mold set relative to the hot runner in a second direction comprises:
actuating a clamp to actuate a mold stack incorporating the mold set and the hot runner into a mold closed configuration.

25. The method of claim 24, wherein said, guiding the cavity half of the mold set relative to the hot runner in a second direction further comprises:
after said actuating, partially securing the core half and the cavity half.

26. The method of claim 23, wherein said, guiding the cavity half of the mold set relative to the hot runner in a second direction further comprises:
after said partially securing, unlatching the core half and the cavity half.

27. The method of claim 26, wherein said, guiding the cavity half of the mold set relative to the hot runner in a second direction further comprises:
after said unlatching, fully securing the core half and the cavity half.

28. A mold stack comprising:
a hot runner operatively coupled, in use, to a source of molten material, the hot runner further including a guiding member;
a mold set including a core half and a cavity half, the cavity half and the core half configured to define, in use, at least one molding cavity for receiving, in use, molten material from the hot runner for forming a molded article; the cavity half further including a guided member;
the guiding member and the guided member configured to cooperate to guide the mold set relative to the hot runner in a first direction and, sequentially, in a second direction, the second direction traversing the first direction.

29. The mold stack of claim 28, the mold stack being of a two-level type, and wherein
said hot runner comprises two instances of the hot runner;
said core half comprises two instances of the core half;
said cavity half comprises two instances of the cavity half;
the guiding member comprises two instances of the guiding member;
the guided member comprises two instances of the guided member; and wherein the mold stack further includes:
a machine carrier for coupling, in use, the two instances of the cavity half onto a molding machine and for accommodating, in use, the two instances of the hot runner.

30. The mold stack of claim 28, the mold stack being of a three-level type, and wherein
said hot runner comprises three instances of the hot runner;
said core half comprises three instances of the core half;
said cavity half comprises three instances of the cavity half;
the guiding member comprises three instances of the guiding member;
the guided member comprises three instances of the guided member; and wherein the mold stack further includes:
a first machine carrier for coupling, in use, two of the three instances of the cavity half onto a molding machine and for accommodating, in use, two of the three instances of the hot runner; and
a second machine carrier for coupling, in use, two of the three instances of the core half onto the molding machine.

31. The mold stack of claim 28, the mold stack being of a four-level type, and wherein
said hot runner comprises four instances of the hot runner;
said core half comprises four instances of the core half;
said cavity half comprises four instances of the cavity half;
the guiding member comprises four instances of the guiding member;
the guided member comprises four instances of the guided member; and wherein the mold stack further includes:
a first machine carrier for coupling, in use, two of the four instances of the cavity half onto a molding machine and for accommodating, in use, two of the four instances of the hot runner; and
a second machine carrier for coupling, in use, two of the four instances of the core half onto the molding machine; and
a third machine carrier for coupling, in use, the other two of the four instances of the cavity half onto the molding machine and for accommodating, in use, two of the four instances of the hot runner.
